(19) United States
(12) Patent Application Publication
(10) Pub. No.: US 2011/0076424 A1
(43) Pub. Date: Mar. 31, 2011

(54) MICROSTRUCTURES COMPRISING POLYALKYL NITROGEN OR PHOSPHORUS ONIUM FLUOROALKYL SULFONYL SALTS

(75) Inventors: Mark J. Pellerite, Woodbury, MN (US); James E. Lockridge, St.Paul, MN (US); William M. Lamanna, St.Paul, MN (US)

(73) Assignee: 3M Innovative Properties Company

(21) Appl. No.: 12/937,804

(22) PCT Filed: May 11, 2009
(86) PCT No.: PCT/US09/43401

§ 371 Date: Oct. 14, 2010

Related U.S. Application Data
(60) Provisional application No. 61/058,276, filed on Jun. 3, 2008.
(60) Provisional application No. 61/085,220, filed on Jul. 31, 2008.

(51) Int. Cl. G02B 1/04; C09K 3/16

(52) U.S. Cl. 428/1.31; 428/1.3

(57) ABSTRACT

Films, such as optical films that comprise a microstructured surface are described. The microstructures comprise the reaction product of a polymerizable resin composition comprising certain polyalkyl nitrogen or phosphorus onium fluoroalkyl sulfonyl salts as an antistatic agent. Also described is a polymerizable resin comprising at least one di(meth)acrylate monomer comprising at least two aromatic rings, a reactive diluent; and the polyalkyl nitrogen or phosphorus onium fluoroalkyl sulfonyl salts as an antistatic agent antistatic agent.

### BACKGROUND

Certain microstructured optical products, such as described in U.S. 2005/0148725, are commonly referred to as a “brightness enhancing films”. Brightness enhancing films are utilized in many electronic products to increase the brightness of a backlit flat panel display such as a liquid crystal display (LCD) including those used in electroluminescent panels, laptop computer displays, word processors, desktop monitors, televisions, video cameras, as well as automotive and aviation displays.

Brightness enhancing films desirably exhibit specific optical and physical properties including the index of refraction of a brightness enhancing film that is related to the brightness gain (i.e. “gain”) produced. Improved brightness can allow the electronic product to operate more efficiently by using less power to light the display, thereby reducing the power consumption, placing a lower heat load on its components, and extending the lifetime of the product.

Brightness enhancing films have been prepared from polymerizable resin compositions comprising high index of refraction monomers that are cured or polymerized. Halogenated (e.g. brominated) monomers or oligomers are often employed to attain refractive indices of for example 1.56 or greater. Another way to attain high refractive index compositions is to employ a polymerizable composition that comprises high refractive index nanoparticles.

### SUMMARY

In one embodiment, a microstructured (e.g. optical) film, such as a brightness enhancing film, is described comprising a polymerized microstructured surface wherein the microstructures comprise the reaction product of a polymerizable resin composition comprising an antistatic agent having the general formula

RₓJH₄₋ₓ^{+ -}A[SO₂R_{f}]ₘ

wherein
x ranges from 3-4;
R is independently a C₁ to C₁₂ alkyl group optionally comprising catenary oxygen atoms or at least one hydroxyl terminal group;
J is nitrogen or phosphorus;
A is a nitrogen or carbon;
R_{f} is independently a fluorinated C₁ to C₄ alkyl group; and
m ranges from 2 to 3.

The microstructures are typically disposed on a (optionally primed) base film layer (such as a polarizing film) having a different composition than the microstructures. In such embodiment, the microstructures exhibit a crosshatch adhesion to the base film layer of at least 90%.

In another embodiment, a polymerizable resin composition is described comprising at least one di(meth)acrylate monomer comprising at least two aromatic rings, a reactive diluent; and an antistatic agent (just described) having the general formula RₓJH₄₋ₓ^{+ -}A[SO₂R_{f}]ₘ.

In each of these embodiments, the antistatic agent may be present in an amount ranging from about 0.5 wt-% to about 15 wt-% solids and preferably about 3 wt-% to about 5 wt-% solids. Further, the charge decay is preferably less than 1.5 seconds and more preferably less than 0.5 seconds when tested at 70° F. and 50% relative humidity.

The sum of the carbon atoms of R is at least 5, 6, 7 or 8. In some embodiments, x is 4 and the sum of the carbon atoms of R is at least 7. In some embodiments, at least one Rf is CF₃. In some embodiments, at least one R is methyl and the other R groups comprise at least 2 carbon atoms. In other embodiments, x is 3, and each R comprises at least 2 carbon atoms. In some embodiments, J is nitrogen. In other embodiments, J is phosphorus x is 4.

In one embodiment, R comprises a hydroxyl terminal group. The polymerizable resin composition preferably further comprises at least one (e.g. mono) carboxylic acid such as acrylic acid, methacrylic acid, and mixtures thereof.

### DETAILED DESCRIPTION

Presently described are (e.g. optical) films comprising a microstructured surface. The microstructures comprise the reaction product of a polymerizable resin composition comprising certain polyalkyl nitrogen or phosphorus onium fluoroalkyl sulfonyl salts as an antistatic agent.

Although the term “conductive” is often used in the industry to refer to “static dissipative”, these terms are not synonymous. Specifically, a conductive material is considered to have a surface resistivity up to 1×10⁵ ohms/sq.; whereas an antistatic material typically has a surface resistivity up to 1×10¹² ohms/sq. The microstructured (e.g. optical) films disclosed herein can exhibit a surface resistivity of at least about 1×10⁷, 1×10⁸, 1×10⁹, 1×10¹⁰ ohms/sq, or 1×10¹¹ ohms/sq yet maintain antistatic properties.

The optical films described herein are typically constructed of a (e.g. preformed) light transmissive base (e.g. film) layer and a light transmissive polymerized microstructured optical layer. The base layer and optical layer can be formed from the same, but are typically formed from different polymeric materials.

As described in Lu et al., U.S. Pat. No. 5,175,030, and Lu, U.S. Pat. No. 5,183,597, a microstructure-bearing article (e.g. brightness enhancing film) can be prepared by a method including the steps of (a) preparing a polymerizable composition; (b) depositing the polymerizable composition onto a master negative microstructured molding surface in an amount barely sufficient to fill the cavities of the master; (c) filling the cavities by moving a bead of the polymerizable composition between a preformed base (such as a PET film) and the master, at least one of which is flexible; and (d) curing the composition. The master can be metallic, such as nickel, nickel-plated copper or brass, or can be a thermoplastic material that is stable under the polymerization conditions, and that preferably has a surface energy that allows clean removal of the polymerized material from the master.

Useful base materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, polyimides, and glass. Optionally, the base material can contain mixtures or combinations of these materials. Further, the base may be multi-layered or may contain a dispersed component suspended or dispersed in a continuous phase.

For some microstructure-bearing products such as brightness enhancement films, examples of preferred base materials include polyethylene terephthalate (PET) and polycarbonate. Examples of useful PET films include photograde polyethylene terephthalate and MELINEX™ PET available from DuPont Films of Wilmington, Del.

Some base materials can be optically active, and can act as polarizing materials. Polarization of light through a film can be accomplished, for example, by the inclusion of dichroic polarizers in a film material that selectively absorbs passing light. Light polarization can also be achieved by including inorganic materials such as aligned mica chips or by a discontinuous phase dispersed within a continuous film, such as droplets of light modulating liquid crystals dispersed within a continuous film. As an alternative, a polarizing film can be prepared from microfine layers of different materials. The materials within the film can be aligned into a polarizing orientation, for example, by employing methods such as stretching the film, applying electric or magnetic fields, and coating techniques.

Examples of polarizing films include those described in U.S. Pat. Nos. 5,825,543 and 5,783,120. The use of these polarizer films in combination with a brightness enhancement film has been described in U.S. Pat. No. 6,111,696. Another example of a polarizing film that can be used as a base are those films described in U.S. Pat. No. 5,882,774.

Useful substrates include commercially available optical films marketed as Vikuiti™ Dual Brightness Enhanced Film (DBEF), Vikuiti™ Brightness Enhanced Film (BEF), Vikuiti™ Diffuse Reflective Polarizer Film (DRPF), Vikuiti™ Enhanced Specular Reflector (ESR), and Vikuiti™ Advanced Polarizing Film (APF), all available from 3M Company.

One or more of the surfaces of the base film material can optionally be primed or otherwise be treated to promote adhesion of the optical layer to the base. Primers particularly suitable for polyester base film layers include sulfopolyester primers, such as described in U.S. Pat. No. 5,427,835. The thickness of the primer layer is typically at least 20 nm and generally no greater than 300 nm to 400 nm.

The optical layer can have any of a number of useful patterns. These include regular or irregular prismatic patterns, which can be an annular prismatic pattern, a cube-corner pattern or any other lenticular microstructure. A useful microstructure is a regular prismatic pattern that can act as a totally internal reflecting film for use as a brightness enhancement film. Another useful microstructure is a corner-cube prismatic pattern that can act as a retro-reflecting film or element for use as reflecting film. Another useful microstructure is a prismatic pattern that can act as an optical turning film or element for use in an optical display.

One preferred optical film having a polymerized microstructured surface is a brightness enhancing film. Brightness enhancing films generally enhance on-axis luminance (referred herein as “brightness”) of a lighting device. The microstructured topography can be a plurality of prisms on the film surface such that the films can be used to redirect light through reflection and refraction. The height of the prisms typically ranges from about 1 to about 75 microns. When used in an optical display such as that found in laptop computers, watches, etc., the microstructured optical film can increase brightness of an optical display by limiting light escaping from the display to within a pair of planes disposed at desired angles from a normal axis running through the optical display. As a result, light that would exit the display outside of the allowable range is reflected back into the display where a portion of it can be “recycled” and returned back to the microstructured film at an angle that allows it to escape from the display. The recycling is useful because it can reduce power consumption needed to provide a display with a desired level of brightness.

The microstructured optical layer of a brightness enhancing film generally comprises a plurality of parallel longitudinal ridges extending along a length or width of the film. These ridges can be formed from a plurality of prism apexes. Each prism has a first facet and a second facet. The prisms are formed on base that has a first surface on which the prisms are formed and a second surface that is substantially flat or planar and opposite first surface. By right prisms it is meant that the apex angle is typically about 90°. However, this angle can range from 70° to 120° and may range from 80° to 100°. These apexes can be sharp, rounded or flattened or truncated. For example, the ridges can be rounded to a radius in a range of 4 to 7 to 15 micrometers. The spacing between prism peaks (or pitch) can be 5 to 300 microns. The prisms can be arranged in various patterns such as described in U.S. Pat. No. 7,074,463; incorporated herein by reference.

For thin brightness enhancing films, the pitch is preferably 10 to 36 microns, and more preferably 18 to 24 microns. This corresponds to prism heights of preferably about 5 to 18 microns, and more preferably about 9 to 12 microns. The prism facets need not be identical, and the prisms may be tilted with respect to each other. The relationship between the total thickness of the optical article, and the height of the prisms, may vary. However, it is typically desirable to use relatively thinner optical layers with well-defined prism facets. For thin brightness enhancing films on substrates with thicknesses close to 1 mil (20-35 microns), a typical ratio of prism height to total thickness is generally between 0.2 and 0.4.

The microstructured (e.g. brightness enhancing films) described herein comprise a polymerized microstructured surface (e.g. microstructured optical layer) wherein the microstructures comprise the reaction product of a polymerizable resin composition comprising an antistatic agent.

Although various antistatic agents can provide static decay times (as measured according to the test method described in the examples) in about 2 to 10 seconds, it has been found that only certain kinds and amounts of antistatic agents can provide static decay times of less 1.5 seconds. Preferred antistatic agents provide static decay times of no greater than 0.5, 0.4, 0.3, 0.2, or 0.1 seconds.

For embodiments wherein the microstructures are disposed upon a base layer such as a light transmissive (e.g. polyester) film, the kind and amount of antistatic agent is also selected such that the presence thereof in the polymerizable resin does not detract from the adhesion of the polymerized microstructures with the base film layer. The microstructures exhibit a crosshatch adhesion (as measured according to the test method described in the examples) to the base film layer of at least 80%, 85%, or 90%. In most preferred embodiments, the crosshatch adhesion is 95-100%.

The antistatic agent is a polyalkyl nitrogen or phosphorus onium fluoroalkyl sulfonyl salt preferably having the general formula

RₓJH₄₋ₓ^{+ -}A[SO₂R_{f}]ₘ

wherein
x ranges from 3-4; and
R is independently a C₁ to C₁₂ alkyl group optionally comprising catenary oxygen atoms or hydroxyl terminal group(s);
J is nitrogen or phosphorus;
A is a nitrogen atom or carbon atom;
R_{f} is independently a fluorinated C₁ to C₄ alkyl group; and
m ranges from 2 to 3.

The sum of the carbon atoms of the R groups is generally at least 5. In some embodiments, the sum of the carbon atoms of R is at least 6, 7, or 8.

For embodiments wherein J is phosphorus, X is preferably 4. In some embodiments, x is 3 and each R comprises at least 2 carbon atoms. For example, the antistatic agent may comprise (C₂H₅)₃NH^{+ -}N(SO₂CF₃)₂, (C₂H₅)₃NH^{+ -}N(SO₂C₄F₉)₂, (C₂H₅)₃NH^{+ -}N(SO₂CF₃)(SO₂C₄F₉), (C₂H₅)₃NH^{+ -}C(SO₂CF₃)₃, (C₂H₅)₃NH^{+ -}N(SO₂C₂F₅)₂, and the like.

In some embodiments, x is 4 and the sum of the carbon atoms of R is at least 7 or 8. For example, at least one R group can be methyl and the other three R groups comprise at least 2 carbon atoms such as exemplified by (C₂H₅)₃N(CH₃)^{+ -}N(SO₂CF₃)₂, (C₄H₉)₃N(CH₃)^{+ -}N(SO₂CF₃)₂, and the like.

Alternatively, all four R group can be ethyl or butyl. For example, the antistatic agent may comprise (C₄H₉)₄N^{+ -}N(SO₂CF₃)₂, (C₂H₅)₄N^{+ -}N(SO₂CF₃)₂, (C₄H₉)₄N^{+ -}C (SO₂CF₃)₃, and the like.

Preferably at least one or two of the Rf groups are trifluoromethyl or trifluoroethyl. However, higher fluoroalkyl groups such as perfluorobutyl can also be employed. For example, the antistatic agent may comprise (C₂H₅)₃NH^{+ -}N(SO₂C₄F₉)₂, (C₆H₁₃)₄N^{+ -}N(SO₂C₂F₅)₂, (C₁₂H₂₅)(CH₃)₃N^{+ -}N(SO₂C₂F₅)₂, and the like.

In general imide salts, i.e. wherein Q is nitrogen, are preferred over methides.

In some embodiments, R preferably comprises at least one hydroxyl terminal group.

Various mixtures of the polyalkyl nitrogen or phosphorus onium fluoroalkyl sulfonyl salts described herein can also be employed.

The total concentration of the polyalkyl nitrogen or phosphorus onium fluoroalkyl sulfonyl salt(s) is preferably greater than about 0.5 or 1 wt-% and in some embodiments preferably 2 or 3 wt-% of the polymerized microstructure and generally no greater than about 10, 11, 12, 13, 14 or 15 wt-%. Concentrations of about 3 wt-% to about 5 wt-% have been shown to provide the preferred static decay properties, i.e. a static decay of less than 0.5, 0.4, 0.3, 0.2, or 0.1 seconds. In some embodiments, such as when an unprimed polarizing base layer is employed, it is typically preferred to employ less than 10 wt-% of the polyalkyl nitrogen or phosphorus onium fluoroalkyl sulfonyl salt, in order to obtain crosshatch adhesion of at least 80 or 90%.

The polyalkyl nitrogen or phosphorus onium fluoroalkyl sulfonyl salts described herein are commercially available or can be synthesized by know techniques, as described in the art. Various patents and patent applications describe the synthesis of polyalkyl nitrogen or phosphorus onium fluoroalkyl sulfonyl imide and/or methide salts including for example U.S. Pat. No. 6,924,329; U.S. Pat. No. 6,784,237; U.S. Pat. No. 6,740,413; U.S. Pat. No. 6,706,920; U.S. Pat. No. 6,592,988; U.S. Pat. No. 6,372,829; and U.S. Patent Publication No. US2003/114560.

The polyalkyl nitrogen or phosphorus onium fluoroalkyl sulfonyl salt(s) can be combined with various polymerizable resin compositions suitable for forming microstructures as known in the art.

The polyalkyl nitrogen or phosphorus onium fluoroalkyl sulfonyl antistat salt(s) may be combined with a carboxylic acid prior to combining the antistat salt with the bulk polymerizable resin composition for forming the microstructures. Representative examples include acrylic acid, methacrylic acid, and mixtures thereof. Various dicarbocylic acids are also surmised to be suitable. The dicarboxylic acids are preferably relatively low in molecular weight. The dicarboxylic acid may be linear or branched. Dicarboxylic acids having up to 6 carbon atoms between the carboxylic acids groups are preferred. These include for example maleic acid, succinic acid, suberic acid, phthalic acid, and itaconic acid.

In some embodiments, the polymerizable resin composition comprises surface modified inorganic nanoparticles. In such embodiments, “polymerizable composition” refers to the total composition, i.e. the organic component and surface modified inorganic nanoparticles.

The organic component as well as the polymerizable composition are preferably substantially solvent free. “Substantially solvent free” refer to the polymerizable composition having less than 5 wt-%, 4 wt-%, 3 wt-%, 2 wt-%, 1 wt-% and 0.5 wt-% of non-polymerizable (e.g. organic) solvent. The concentration of solvent can be determined by known methods, such as gas chromatography (as described in ASTM D5403). Solvent concentrations of less than 0.5 wt-% are preferred.

The components of the organic component are preferably chosen such that the polymerizable resin composition has a low viscosity. In some embodiments, the viscosity of the organic component is less than 1000 cps and typically less than 900 cps at the coating temperature. The viscosity of the organic component may be less than 800 cps, less than 700 cps, less than 600 cps, or less than 500 cps at the coating temperature. As used herein, viscosity is measured (at a shear rate up to 1000 sec−1) with 25 mm parallel plates using a Dynamic Stress Rheometer. Further, the viscosity of the organic component is typically at least 10 cps, more typically at least 50 cps at the coating temperature.

The coating temperature typically ranges from ambient temperature, 77° F. (25° C.) to 180° F. (82° C.). The coating temperature may be less than 170° F. (77° C.), less than 160° F. (71° C.), less than 150° F. (66° C.), less than 140° F. (60° C.), less than 130° F. (54° C.), or less than 120° F. (49° C.). The organic component can be a solid or comprise a solid component provided that the melting point in the polymerizable composition is less than the coating temperature. The organic components described herein are preferably liquids at ambient temperature.

The organic component has a refractive index of at least 1.54, 1.55, 1.56, 1.57, 1.58, 1.59, 1.60, or 1.61. The polymerizable composition including high refractive index nanoparticles can have a refractive index as high as 1.70. (e.g. at least 1.61, 1.62, 1.63, 1.64, 1.65, 1.66, 1.67, 1.68, or 1.69). High transmittance in the visible light spectrum is also typically preferred.

The polymerizable composition is energy curable in time scales preferably less than five minutes (e.g. for a brightness enhancing film having a 75 micron thickness). The polymerizable composition is preferably sufficiently crosslinked to provide a glass transition temperature that is typically greater than 45° C. The glass transition temperature can be measured by methods known in the art, such as Differential Scanning calorimetry (DSC), modulated DSC, or Dynamic Mechanical Analysis. The polymerizable composition can be polymerized by conventional free radical polymerization methods.

The polymerizable resin composition can comprise a variety of aromatic monomers and/or oligomers. The polymerizable resin composition preferably comprises at least one di(meth)acrylate monomer or oligomer comprising at least two aromatic rings. Such di(meth)acrylate monomers typically a molecular weight of at least 350 g/mole, 400 g/mole, or 450 g/mole.

The aromatic monomer or oligomer having at least two polymerizable (meth)acrylate groups may be synthesized or purchased. The aromatic monomer or oligomer typically contains a major portion, i.e. at least 60-70 wt-%, of a specific structure. It is commonly appreciated that other reaction products are also typically present as a byproduct of the synthesis of such monomers.

In some embodiments, the polymerizable composition comprises at least one aromatic (optionally brominated) difunctional (meth)acrylate monomer that comprises a major portion having the following general structure:

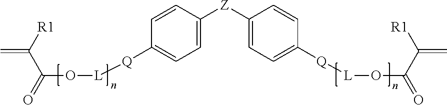

wherein Z is independently —C(CH₃)₂—, —CH₂—, —C(O)—, —S—, —S(O)—, or —S(O)₂—, each Q is independently O or S. L is a linking group. L may independently comprise a branched or linear C₂-C₁₂ alkyl group and n ranges from 0 to 10. L preferably comprises a branched or linear C₂-C₆ alkyl group. More preferably L is C₂ or C₃ and n is 0, 1, 2 or 3. The carbon chain of the alkyl linking group may optionally be substituted with one or more hydroxy groups. For example L may be —CH₂CH(OH)CH₂—. Typically, the linking groups are the same. R1 is independently hydrogen or methyl.

In some embodiments, the aromatic monomer is a bisphenol di(meth)acrylate, i.e. the reaction product of a bisphenol A diglycidyl ether and acrylic acid. Although bisphenol A diglycidyl ether is generally more widely available, it is appreciated that other bisphenol diglycidyl ether such as bisphenol F diglycidyl ether could also be employed. For example, the di(meth)acrylate monomer can be the reaction product of Tetrabromobisphenol A diglycidyl ether and acrylic acid. Such monomer may be obtained from UCB Corporation, Smyrna, Ga. under the trade designation “RDX-51027”. This material comprises a major portion of 2-propenoic acid, (1-methylethylidene)bis[(2,6-dibromo-4,1-phenylene)oxy(2-hydroxy-3,1-propanediyl)]ester.

One exemplary bisphenol-A ethoxylated diacrylate monomer is commercially available from Sartomer under the trade designations “SR602” (reported to have a viscosity of 610 cps at 20° C. and a Tg of 2° C.). Another exemplary bisphenol-A ethoxylated diacrylate monomer is as commercially available from Sartomer under the trade designation “SR601” (reported to have a viscosity of 1080 cps at 20° C. and a Tg of 60° C.).

Alternatively or in addition to, the organic component may comprise one or more (meth)acrylated aromatic epoxy oligomers. Various (meth)acrylated aromatic epoxy oligomers are commercially available. For example, (meth)acrylated aromatic epoxy, (described as a modified epoxy acrylates), are available from Sartomer, Exton, Pa. under the trade designation “CN118”, and “CN115”. (Meth)acrylated aromatic epoxy oligomer, (described as an epoxy acrylate oligomer), is available from Sartomer under the trade designation “CN2204”. Further, a (meth)acrylated aromatic epoxy oligomer, (described as an epoxy novolak acrylate blended with 40% trimethylolpropane triacrylate), is available from Sartomer under the trade designation “CN112C60”. One exemplary aromatic epoxy acrylate is commercially available from Sartomer under the trade designation “CN 120” (reported by the supplier to have a refractive index of 1.5556, a viscosity of 2150 at 65° C., and a Tg of 60° C.).

In some embodiments, the polymerizable resin composition comprises at least one difunctional biphenyl(meth)acrylate monomer that comprises a major portion having the following general structure:

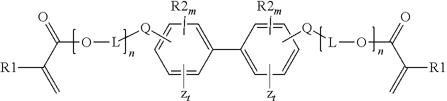

wherein each R1 is independently H or methyl;
each R2 is independently Br;
m ranges from 0 to 4;
each Q is independently O or S;
n ranges from 0 to 10;
L is a C2 to C12 alkyl group optionally substituted with one or more hydroxyl groups;
z is an aromatic ring; and
t is independently 0 or 1.

In some aspects, Q is preferably O. Further, n is typically 0, 1 or 2. L is typically C₂ or C₃. Alternatively, L is typically a hydroxyl substituted C₂ or C₃. In some embodiments, z is preferably fused to the phenyl group thereby forming a binapthyl core structure.

Preferably, at least one of the -Q[L-O]n C(O)C(R1)═CH₂ groups is substituted at the ortho or meta position. More preferably, the biphenyl di(meth)acrylate monomer comprises a sufficient amount of ortho and/or meta (meth)acrylate substituents such that the monomer is a liquid at 25° C. In some embodiments, each (meth)acrylate group containing substituent is bonded to an aromatic ring group at an ortho or meta position. It is preferred that the biphenyl di(meth)acrylate monomer comprises a major amount of ortho (meth)acrylate substituents (i.e. at least 50%, 60%, 70%, 80%, 90%, or 95% of the substituents of the biphenyl di(meth)acrylate monomer). In some embodiments, each (meth)acrylate group containing substituent is bonded to an aromatic ring group at an ortho or meta position. As the number of meta- and particularly para-substituents increases, the viscosity of the organic components can increase as well. Further, para-biphenyl di(meth)acrylate monomers are solids at room temperature, with little solubility (i.e. less than 10%), even in phenoxyethyl acrylate and tetrahydrofurfuryl acrylate.

Such biphenyl monomers are described in further detail in 60/893,953, filed Mar. 9, 2007. Other biphenyl di(meth)acrylate monomer are described in the literature.

The polymerizable resin composition may optionally comprise one or more (e.g. monofunctional) (meth)acrylate diluents. The total amount of (meth)acrylate diluent(s) can be at least 5 wt-%, 10 wt-%, 15 wt-%, 20 wt-%, or 25 wt-% of the polymerizable composition. The total amount of (meth)acrylate diluents(s) is typically no greater than 40 wt-%, and more typically no greater than about 35 wt-%.

In some embodiments, a multi-functional (meth)acrylate crosslinker may be employed as a diluent. For example, tetraethylene glycol diacrylate such as commercially available from Sartomer under the trade designation SR 268 has been found to be a suitable diluent. Other suitable multi-functional diluents include SR351, trimethylol propane triacrylate (TMPTA).

When one or more aromatic (e.g. monofunctional) (meth)acrylate monomer(s) are employed as the diluent, such diluent can concurrently raise the refractive index of the polymerizable resin composition. Suitable aromatic monofunctional (meth)acrylate monomers typically have a refractive index of at least 1.50, 1.51, 1.52, 1.53, 1.54, 1.55, 1.56, 1.57 or 1.58.

Aromatic (e.g. monofunctional) (meth)acrylate monomers typically comprise a phenyl, cumyl, biphenyl, or napthyl group.

Suitable monomers include phenoxyethyl(meth)acrylate; phenoxy-2-methylethyl (meth)acrylate; phenoxyethoxyethyl(meth)acrylate, 3-hydroxy-2-hydroxypropyl (meth)acrylate; benzyl(meth)acrylate; phenylthio ethyl acrylate; 2-naphthylthio ethyl acrylate; 1-naphthylthio ethyl acrylate; naphthyloxy ethyl acrylate; 2-naphthyloxy ethyl acrylate; phenoxy 2-methylethyl acrylate; phenoxyethoxyethyl acrylate; 3-phenoxy-2-hydroxy propyl acrylate; and phenyl acrylate.

Phenoxyethyl acrylate is commercially available from more than one source including from Sartomer under the trade designation “SR339”; from Eternal Chemical Co. Ltd. under the trade designation “Etermer 210”; and from Toagosei Co. Ltd under the trade designation “TO-1166”. Phenylthio ethyl acrylate (PTEA) is also commerically available from Cognis. The structure of these monomers is shown as follows:

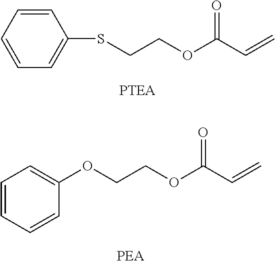

In some embodiments, the polymerizable compositions comprise one or more monofunctional biphenyl monomer(s).

Monofunctional biphenyl monomers comprise a terminal biphenyl group (wherein the two phenyl groups are not fused, but joined by a bond) or a terminal group comprising two aromatic groups joined by a linking group (e.g. Q). For example, when the linking group is methane, the terminal group is a biphenylmethane group. Alternatively, wherein the linking group is —(C(CH₃)₂—, the terminal group is 4-cumyl phenyl. The monofunctional biphenyl monomer(s) also comprise a single ethylenically unsaturated group that is preferably polymerizable by exposure to (e.g. UV) radiation. The monofunctional biphenyl monomer(s) preferably comprise a single (meth)acrylate group or single thio(meth)acrylate group. Acrylate functionality is typically preferred. In some aspects, the biphenyl group is joined directly to the ethylenically unsaturated (e.g. (meth)acrylate) group. An exemplary monomer of this type is 2-phenyl-phenyl acrylate. The biphenyl mono(meth)acrylate or biphenyl thio(meth)acrylate monomer may further comprise a (e.g. 1 to 5 carbon) alkyl group optionally substituted with one or more hydroxyl groups. An exemplary species of this type is 2-phenyl-2-phenoxyethyl acrylate.

In one embodiment, a monofunctional biphenyl(meth)acrylate monomer is employed having the general structure:

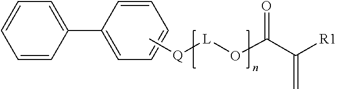

wherein R1 is H or CH₃;

Q is O or S;

n ranges from 0 to 10 (e.g. n is 1, 2, 3, 4, 5, 6, 7, 8, 9, or 10); and

L is preferably an alkyl group having 1 to 5 carbon atoms (i.e. methyl, ethyl, propyl, butyl, or pentyl), optionally substituted with hydroxy.

In another embodiment, the monofunctional biphenyl(meth)acrylate monomer has the general structure:

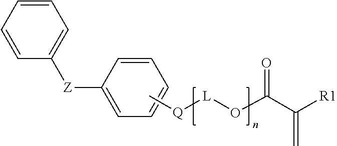

wherein R1 is H or CH₃;

Q is O or S;

Z is selected from —(C(CH₃)₂—, —CH₂, —C(O)—, —S(O)—, and —S(O)₂—;

n ranges from 0 to 10 (e.g. n is 1, 2, 3, 4, 5, 6, 7, 8, 9, or 10); and

L is an alkyl group having 1 to 5 carbon atoms (i.e. methyl, ethyl, butyl, or pentyl), optionally substituted with hydroxy.

Some specific monomers that are commercially available from Toagosei Co. Ltd. of Japan, include for example 2-phenyl-phenyl acrylate available under the trade designation “TO-2344”, 4-(-2-phenyl-2-propyl)phenyl acrylate available under the trade designation “TO-2345”, and 2-phenyl-2-phenoxyethyl acrylate, available under the trade designation “TO-1463”.

Various combinations of aromatic monofunctional (meth)acrylate monomers can be employed. For example, a (meth)acrylate monomer comprising a phenyl group may be employed in combination with one or more (meth)acrylate monomers comprising a biphenyl group. Further, two different biphenyl(meth)acrylate monofunctional monomera may be employed.

The polymerizable resin may optionally comprise up to 35 wt-% of various other (e.g. non-halogenated) ethylenically unsaturated monomers. For example, when the (e.g. prism) structures are cast and photocured upon a polycarbonate preformed polymeric film the polymerizable resin composition may comprise one or more N,N-disubstituted (meth)acrylamide monomers. These include N-alkylacrylamides and N,N-dialkylacrylamides, especially those containing C₁₋₄ alkyl groups. Examples are N-isopropylacrylamide, N-t-butylacrylamide, N,N-dimethylacrylamide, N,N-diethylacrylamide, N-vinyl pyrrolidone and N-vinyl caprolactam.

The polymerizable resin composition may also optionally comprise up to 20 wt-% of a non-aromatic crosslinker that comprises at least three (meth)acrylate groups. Suitable crosslinking agents include for example pentaerythritol tri(meth)acrylate, pentaerythritol tetra(meth)acrylate, trimethylolpropane tri(methacrylate), dipentaerythritol penta(meth)acrylate, dipentaerythritol hexa(meth)acrylate, trimethylolpropane ethoxylate tri(meth)acrylate, glyceryl tri(meth)acrylate, pentaerythritol propoxylate tri(meth)acrylate, and ditrimethylolpropane tetra(meth)acrylate. Any one or combination of crosslinking agents may be employed. Since methacrylate groups tend to be less reactive than acrylate groups, the crosslinker(s) are preferably free of methacrylate functionality.

Various crosslinkers are commercially available. For example, pentaerythritol triacrylate (PETA) is commercially available from Sartomer Company, Exton, Pa. under the trade designation “SR444”; from Osaka Organic Chemical Industry, Ltd. Osaka, Japan under the trade designation “Viscoat #300”; from Toagosei Co. Ltd., Tokyo, Japan under the trade designation “Aronix M-305”; and from Eternal Chemical Co., Ltd., Kaohsiung, Taiwan under the trade designation “Etermer 235”. Trimethylol propane triacrylate (TMPTA) is commercially available from Sartomer Company under the trade designations “SR351”. TMPTA is also available from Toagosei Co. Ltd. under the trade designation “Aronix M-309”. Further, ethoxylated trimethylolpropane triacrylate and ethoxylated pentaerythritol triacrylate are commercially available from Sartomer under the trade designations “SR454” and “SR494” respectively.

In some embodiments, it is preferred that the polymerized microstructured surface of the optical film and the polymerizable resin composition are substantially free (i.e. contain less than 1 wt-%) of bromine. In other embodiments, the total amount of bromine in combination with chlorine is less than 1 wt-%. In some aspects, the polymerized microstructured surface or the optical film and the polymerizable resin composition are substantially non-halogenated (i.e. contains less than 1 wt-% total of bromine, chlorine, fluorine and iodine).

The UV curable polymerizable compositions comprise at least one photoinitiator. A single photoinitiator or blends thereof may be employed in the brightness enhancement film of the invention. In general the photoinitiator(s) are at least partially soluble (e.g. at the processing temperature of the resin) and substantially colorless after being polymerized. The photoinitiator may be (e.g. yellow) colored, provided that the photoinitiator is rendered substantially colorless after exposure to the UV light source.

Suitable photoinitiators include monoacylphosphine oxide and bisacylphosphine oxide. Commercially available mono or bisacylphosphine oxide photoinitiators include 2,4,6-trimethylbenzoybiphenylphosphine oxide, commercially available from BASF (Charlotte, N.C.) under the trade designation “Lucirin TPO”; ethyl-2,4,6-trimethylbenzoylphenyl phosphinate, also commercially available from BASF under the trade designation “Lucirin TPO-L”; and bis(2,4,6-trimethylbenzoyl)-phenylphosphine oxide commercially available from Ciba Specialty Chemicals under the trade designation “Irgacure 819”. Other suitable photoinitiators include 2-hydroxy-2-methyl-1-phenyl-propan-1-one, commercially available from Ciba Specialty Chemicals under the trade designation “Darocur 1173” as well as other photoinitiators commercially available from Ciba Specialty Chemicals under the trade designations “Darocur 4265”, “Irgacure 651”, “Irgacure 1800”, “Irgacure 369”, “Irgacure 1700”, and “Irgacure 907”.

The photoinitiator can be used at a concentration of about 0.1 to about 10 weight percent. More preferably, the photoinitiator is used at a concentration of about 0.5 to about 5 wt-%. Greater than 5 wt-% is generally disadvantageous in view of the tendency to cause yellow discoloration of the brightness enhancing film. Other photoinitiators and photoinitiator may also suitably be employed as may be determined by one of ordinary skill in the art.

Surfactants such as fluorosurfactants and silicone based surfactants can optionally be included in the polymerizable composition to reduce surface tension, improve wetting, allow smoother coating and fewer defects of the coating, etc.

In some embodiments, the polymerizable composition further comprises inorganic nanoparticles.

Surface modified (e.g. colloidal) nanoparticles can be present in the polymerized structure in an amount effective to enhance the durability and/or refractive index of the article or optical element. In some embodiments, the total amount of surface modified inorganic nanoparticles can be present in the polymerizable resin or optical article in an amount of at least 10 wt-%, 20 wt-%, 30 wt-% or 40 wt-%. The concentration is typically less than to 70 wt-%, and more typically less than 60 wt-% in order that the polymerizable resin composition has a suitable viscosity for use in cast and cure processes of making microstructured films.

The size of such particles is chosen to avoid significant visible light scattering. It may be desirable to employ a mixture of inorganic oxide particle types to optimize an optical or material property and to lower total composition cost. The surface modified colloidal nanoparticles can be oxide particles having a (e.g. unassociated) primary particle size or associated particle size of greater than 1 nm, 5 nm or 10 nm. The primary or associated particle size is generally and less than 100 nm, 75 nm, or 50 nm. Typically the primary or associated particle size is less than 40 nm, 30 nm, or 20 nm. It is preferred that the nanoparticles are unassociated. Their measurements can be based on transmission electron microscopy (TEM). The nanoparticles can include metal oxides such as, for example, alumina, zirconia, titania, mixtures thereof, or mixed oxides thereof. Surface modified colloidal nanoparticles can be substantially fully condensed.

Fully condensed nanoparticles (with the exception of silica) typically have a degree of crystallinity (measured as isolated metal oxide particles) greater than 55%, preferably greater than 60%, and more preferably greater than 70%. For example, the degree of crystallinity can range up to about 86% or greater. The degree of crystallinity can be determined by X-ray diffraction techniques. Condensed crystalline (e.g. zirconia) nanoparticles have a high refractive index whereas amorphous nanoparticles typically have a lower refractive index.

Zirconia and titania nanoparticles can have a particle size from 5 to 50 nm, or 5 to 15 nm, or 8 nm to 12 nm. Zirconia nanoparticles can be present in the durable article or optical element in an amount from 10 to 70 wt-%, or 30 to 60 wt-%. Zirconias for use in composition and articles of the invention are available from Nalco Chemical Co. under the trade designation “Nalco OOSSOO8” and from Buhler AG Uzwil, Switzerland under the trade designation “Buhler zirconia Z-WO sol”.

The zirconia particles can be prepared using hydrothermal technology as described in U.S. Pat. No. 7,241,437. The nanoparticles are surface modified. Surface modification involves attaching surface modification agents to inorganic oxide (e.g. zirconia) particles to modify the surface characteristics. The overall objective of the surface modification of the inorganic particles is to provide resins with homogeneous components and preferably a low viscosity that can be prepared into films (e.g. using cast and cure processes) with high brightness.

The nanoparticles are often surface-modified to improve compatibility with the organic matrix material. The surface-modified nanoparticles are often non-associated, non-agglomerated, or a combination thereof in an organic matrix material. The resulting light management films that contain these surface-modified nanoparticles tend to have high optical clarity and low haze. The addition of the high refractive index surface-modified nanoparticles, such as zirconia, can increase the gain of brightness enhancement film compared to films that contain only polymerized organic material.

The monocarboxylic acid surface treatments preferably comprise a compatibilizing group. The monocarboxylic acids may be represented by the formula A-B where the A group is a (e.g. monocarboxylic acid) group capable of attaching to the surface of a (e.g. zirconia or titania) nanoparticle, and B is a compatibilizing group that comprises a variety of different functionalities. The carboxylic acid group can be attached to the surface by adsorption and/or formation of an ionic bond. The compatibilizing group B is generally chosen such that it is compatible with the polymerizable resin of the (e.g. brightness enhancing) optical article. The compatibilizing group B can be reactive or nonreactive and can be polar or non-polar.

Compatibilizing groups B that can impart non-polar character to the zirconia particles include, for example, linear or branched aromatic or aliphatic hydrocarbons. Representative examples of non-polar modifying agents having carboxylic acid functionality include octanoic acid, dodecanoic acid, stearic acid, oleic acid, and combinations thereof.

The compatibilizing group B may optionally be reactive such that it can copolymerize with the organic matrix of the (e.g. brightness enhancing) optical article. For instance, free radically polymerizable groups such as (meth)acrylate compatibilizing groups can copolymerize with (meth)acrylate functional organic monomers to generate brightness enhancement articles with good homogeneity.

Suitable surface modifications are described in U.S. Publication No. 2007/0112097 and U.S. Ser. No. 60/891,812, filed Feb. 27, 2007.

The surface modified particles can be incorporated into the curable (i.e. polymerizable) resin compositions in various methods. In a preferred aspect, a solvent exchange procedure is utilized whereby the resin is added to the surface modified sol, followed by removal of the water and co-solvent (if used) via evaporation, thus leaving the particles dispersed in the polymerizable resin. The evaporation step can be accomplished for example, via distillation, rotary evaporation or oven drying. In another aspect, the surface modified particles can be extracted into a water immiscible solvent followed by solvent exchange, if so desired. Alternatively, another method for incorporating the surface modified nanoparticles in the polymerizable resin involves the drying of the modified particles into a powder, followed by the addition of the resin material into which the particles are dispersed. The drying step in this method can be accomplished by conventional means suitable for the system, such as, for example, oven drying or spray drying.

A common way of measuring the effectiveness of such recycling of light is to measure the gain of an optical film. As used herein, “relative gain”, is defined as the on-axis luminance, as measured by the test method described in the examples, when an optical film (or optical film assembly) is placed on top of the light box, relative to the on-axis luminance measured when no optical film is present on top of the light box. This definition can be summarized by the following relationship:

Relative Gain=(Luminance measured with optical film)/(Luminance measured without optical film)

For the following defined terms, these definitions shall be applied, unless a different definition is given in the claims or elsewhere in this specification.

The term “microstructure” is used herein as defined and explained in U.S. Pat. No. 4,576,850. Thus, it means the configuration of a surface that depicts or characterizes the predetermined desired utilitarian purpose or function of the article having the microstructure. Discontinuities such as projections and indentations in the surface of said article will deviate in profile from the average center line drawn through the microstructure such that the sum of the areas embraced by the surface profile above the center line is equal to the sum of the areas below the line, said line being essentially parallel to the nominal surface (bearing the microstructure) of the article. The heights of said deviations will typically be about +/−0.005 to +/−750 microns, as measured by an optical or electron microscope, through a representative characteristic length of the surface, e.g., 1-30 cm. Said average center line can be plano, concave, convex, aspheric or combinations thereof. Articles where said deviations are of low order, e.g., from +/−0.005 +/−0.1 or, preferably, +/−0.05 microns, and said deviations are of infrequent or minimal occurrence, i.e., the surface is free of any significant discontinuities, are those where the microstructure-bearing surface is an essentially “flat” or “smooth” surface, such articles being useful, for example, as precision optical elements or elements with a precision optical interface, such as ophthalmic lenses. Articles where said deviations are of low order and of frequent occurrence include those having anti-reflective microstructure. Articles where said deviations are of high-order, e.g., from +/−0.1 to +/−750 microns, and attributable to microstructure comprising a plurality of utilitarian discontinuities which are the same or different and spaced apart or contiguous in a random or ordered manner, are articles such as retroreflective cube-corner sheeting, linear Fresnel lenses, video discs and brightness enhancing films. The microstructure-bearing surface can contain utilitarian discontinuities of both said low and high orders. The microstructure-bearing surface may contain extraneous or non-utilitarian discontinuities so long as the amounts or types thereof do not significantly interfere with or adversely affect the predetermined desired utilities of said articles.

“Index of refraction,” or “refractive index,” refers to the absolute refractive index of a material (e.g., a monomer) that is understood to be the ratio of the speed of electromagnetic radiation in free space to the speed of the radiation in that material. The refractive index can be measured using known methods and is generally measured using an Abbe refractometer or Bausch and Lomb Refractometer (CAT No. 33.46.10) in the visible light region (available commercially, for example, from Fisher Instruments of Pittsburgh, Pa.). It is generally appreciated that the measured index of refraction can vary to some extent depending on the instrument.

“(Meth)acrylate” refers to both acrylate and methacrylate compounds.

The term “nanoparticles” is defined herein to mean particles (primary particles or associated primary particles) with a diameter less than about 100 nm.

“Surface modified colloidal nanoparticle” refers to nanoparticles each with a modified surface such that the nanoparticles provide a stable dispersion.

“Stable dispersion” is defined herein as a dispersion in which the colloidal nanoparticles do not agglomerate after standing for a period of time, such as about 24 hours, under ambient conditions—e.g. room temperature (about 20-22° C.), atmospheric pressure, and no extreme electromagnetic forces.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

Unless otherwise indicated, all numbers expressing quantities of ingredients, measurement of properties and so forth used in the specification and claims are to be understood as being modified in all instances by the term “about.”

The present invention should not be considered limited to the particular examples described herein, but rather should be understood to cover all aspects of the invention as fairly set out in the attached claims. Various modifications, equivalent processes, as well as numerous structures to which the present invention can be applicable will be readily apparent to those of skill in the art to which the present invention is directed upon review of the instant specification.

### EXAMPLES

### Test Methods

### Cross-Hatch Adhesion

Adhesion of the microstructured resin layer to the base DBEF films was determined using a crosshatch test and 3M 610 cellophane adhesive tape according to test method ASTM D3359.

The adhesion was rated on a scale of 0 to 5, where 0 means 100% coating was removed, while 5 means 0% coating was removed. (Hence “4” is equivalent to about 80% retention or 20% removed.)

Surface resistivities were measured using a ProStat (Bensenville, Ill.) PRS-801 resistance system equipped with a PRF-911 concentric ring fixture. Surface resistivities in ohms were converted to ohms/sq by multiplying the measured values by 10 according to the documentation supplied with the instrument.

Static charge decay times were measured using an Electro-Tech Systems, Inc. Model 406C static decay meter. This instrument charges the sample to 5 kV and measures the time required for the static charge to decay to 10% of its initial value. Some insulating samples would not charge fully to 5 kV, and this is noted in the data tables as WNC.

### Blooming Test

The propensity of an antistat to migrate to the surface and transfer to other films was evaluated by placing the microreplicated surface against a clean, unprimed sheet of PET. This stack was then placed between ⅛″ sheets of glass which were held apart by 1/16″ spacers. These panels were then placed in a chamber at 65° C. and 95% relative humidity for 72 hrs. The polyester was then visually inspected for discoloration and evidence of transfer of the antistatic additive. A “P” indicates a passing evaluation or no transfer observed while a “NP” indicates that a residue was deposited on the PET.

### Antistatic Agents

### Generic Chemical Description (Trade Designation, Supplier)

1. Tributylmethylammonium bis(trifluoromethanesulfonyl)imide (available from 3M Company, St. Paul, Minn. under the trade designation “L-19055”), lithium bis(trifluoromethanesulfonyl)imide (available from 3M Company, under the trade designation “HQ-115”),
2. N,N-bis(2-hydroxyethyl)-N-(3′-dodecyloxy-2′-hydroxypropyl)methyl ammonium methosulfate (obtained from Cytec Industries under the trade designation “Cyastat 609”)
3. Choline chloride was obtained from Aldrich Chemical Co.
4. N,N-diethylaminoethyl acrylate Q-salt, methosulfate (50% aq.) was purchased from Monomer-Polymer & Dajac Labs, Inc, catalog no. 8592

The other antistatic agents described in Tables 1-3 were synthesized as described in the previously cited patents and patent applications.

Two different base layer film substrates were used in the examples. The first substrate was an (i.e. unprimed) multilayer optical film that is that same base layer film substrate as a brightness enhancing film commercially available from 3M Company under the trade designation “Vikuiti™ DBEF II”.

The second substrate was a multilayer reflective polarizing optical film prepared according to Example 11 of U.S. Pat. No. 6,352,761. The second substrate was coated with a sulfonated polyester resins crosslinked with Cymel 327 melamine/formaldehyde resin as described in U.S. patent application 61/040,737 file Mar. 31, 2008 at a cured primer thickness of about 250 nm.

The polymerizable resin consisted of 25 wt % phenoxyethylacrylate and 75 wt % bisphenol A epoxy acrylate (CN120) and containing 0.5 wt % Darocur 1173 and 0.5 wt % TPO as photoinitiators. The polymerizable resin was modified using the salts shown in Tables 1-3 by mixing 2 g salt and 18 g resin in an amber screw-top vial, sealing the vial, and heating the mixture in an oven at 90° C. for several minutes to dissolve the salt. All of the salts except choline chloride dissolved easily to give clear modified resins after cooling to room temperature.

The resins were applied to each substrate using the following procedure.
1) Heat the resin at 60° C. for 1 hr until liquefied.
2) Heat a flat BEF tool in contact with the substrate film to be coated on a hot plate at 160° F. for 1 min.
3) Heat a Catena 35 laminator to 160° F. and set speed to 35 in/min.
4) Apply a bead line of resin to the tool.
5) Using a hand roller, gently place the substrate film against the tool and roll to tack in place.
6) Sandwich the tool+film sample between two larger pieces of unprimed PET film to protect the laminator rolls.
7) Run sample through the laminator at the highest setting. This gives a nominal resin film thickness of 0.4 mil.
8) Pass sample through a UV processor (UV Fusion Lighthammer equipped with a D bulb and operating at 100% power and 30 ft/min line speed under nitrogen purging).
9) Gently remove film sample from tool.

All samples released easily from the tool.

The laminates were allowed to condition overnight in a constant temperature/humidity chamber at 70F/50% RH overnight, then subjected to measurement of surface resistivity, static decay time, and crosshatch adhesion. Results are shown in Tables 1-3 below. For the static decay measurements, samples were oriented so as to place the microstructured prism rows perpendicular or parallel to the test electrodes.

TABLE 1
Antistatic Salts in Polymerizable Resin on Primed Second Substrate

| | | | | CD (sec) Prisms | Crosshatch |
|---|---|---|---|---|---|
| | | Salt Level | SR | perpendicular | Adhesion |
| Sample | Salt | (wt %) | (ohm/sq) | to electrodes | (%) |
| 1 | L-19055 | 10 | 8.7E10 | 0.07 | 100 |
| 2 (Comp.) | HQ115 | 10 | 1.2E12 | >30 | 100 |
| 3 (Comp.) | Cyastat 609 | 10 | 2.6E11 | 1.75 | 20 |
| 4 (Comp.) | Li⁺C₄F₉SO₃⁻ | 10 | 2.6E9 | 3.8 | 100 |
| 5 (Comp.) | Bu₄P⁺C₄F₉SO₃⁻ | 10 | 1.4E12 | 2.3 | 100 |
| 6 (Comp.) | Bu₄N⁺C₄F₉SO₃⁻ | 10 | 4.3E12 | 8.09 | 99 |
| 7 (Comp.) | Choline Chloride | 10 | 4.2E12 | WNC | 100 |
| Control | None | 0 | 5.5E12 | WNC | 100 |

The laminate containing L-19055 was allowed to stand overnight in the ambient laboratory atmosphere at 22% RH. Static charge decay was remeasured and found to have not changed significantly, implying that this antistat system can give good performance even in low ambient humidity.

### Examples 2-6

The procedure of Example 1 was repeated using the modified resin formulations shown in Tables 2-3. DBEF II was used as the substrate, and temperatures were controlled at 68° C. Laminates were subjected to measurement of static charge decay time after standing overnight in a constant temperature/humidity chamber at 70F/50% RH. Results are shown in Tables 2-3.

TABLE 2
Antistatic Salts in the Polymerizable Resin on MOF Substrate
of “Vikuiti ™ DBEF II”

| | | | CD (sec) | |
|---|---|---|---|---|
| | | Salt | Prisms | Crosshatch |
| | | Level | perpendicular | Adhesion |
| Sample | Salt | (wt %) | to electrodes | (%) |
| 2 | L-19055 | 10 | 0.07 | 50 |
| 3 | L-19055 | 5 | 0.1 | 90 |
| 4 | L-19055 | 3 | 1.1 | 50 |
| 5 | L-19055 | 2 | >30 | 90 |
| 6 | L-19055 | 1 | WNC | 100 |
| 7 (Comp.) | Cyastat 609 | 10 | 0.44 | 20 |
| 8 (Comp.) | Cyastat 609 | 5 | 1.8 | 80 |
| 9 (Comp.) | Bu₄P⁺C₄F₉SO₃⁻ | 10 | 1.8 | 20 |
| 10 (Comp.) | Li⁺C₄F₉SO₃⁻ | 10 | 4 | 0 |
| 11 (Comp.) | Li⁺C₄F₉SO₃⁻ | 5 | >30 | NM |
| 11 (Comp.) | Bu₄P⁺C₄F₉SO₃⁻ | 5 | 12 | 70 |
| Control | None | 0 | WNC | 80 |

L-19055 shows the best balance of properties among the various salts tested, and the best antistatic performance at low levels (<5 wt %) in the polymerizable resin. Also, the higher process temperature used in this example was necessary in order to obtain adhesion of the cured resin to the DBEF II substrate. At 60° C., resin adhesion was poor.

Other antistatic agents that provided a suitable combination of charge decay and cross hatch adhesion are set forth as follows:

TABLE 3
Antistatic Salts in the Polymerizable Resin on MOF Substrate of “Vikuiti ™
DBEF II”

| | | | Charge decay | | |
|---|---|---|---|---|---|
| | | | Prisms | Prisms | |
| | | | parallel to | perpendicular | |
| Sample ID | Salt | Loading | electrodes | to electrodes | Crosshatch |
| 7A | Bu₄N⁺ Imide | 10 | ±0.54 | ±0.21 | 5 |
| 7B | Bu₄N⁺ Imide | 5 | ±0.74 | ±0.23 | 4 |
| 8A | Bu₄P⁺ Imide | 10 | ±0.30 | ±0.08 | |
| 8B | Bu₄P⁺ Imide | 2.5 | ±13.87 | ±0.91 | |
| 8C | Bu₄P⁺ Imide | 5 | ±0.54 | ±0.15 | |
| 9A | Et₃NMe⁺ Imide | 10 | ±0.06 | ±0.02 | 4 |
| 9B | Et₃NMe⁺ Imide | 5 | ±0.61 | ±0.14 | 5 |
| 10A | Et₃NH⁺ Imide | 10 | ±0.19 | ±0.05 | 4 |
| 10B | Et₃NH⁺ Imide | 5 | ±1.18 | ±0.35 | 5 |
| 11A | Et₃NH⁺ Dibutylimide | 10 | ±0.61 | ±0.18 | 5 |
| 11B | Et₃NH⁺ Dibutylimide | 5 | ±2.34 | ±0.93 | 5 |
| 12A | Et₃NH⁺ Methylbutylimide | 10 | ±0.19 | ±0.06 | 5 |
| 12B | Et₃NH⁺ Methylbutylimide | 5 | ±0.93 | ±0.32 | 5 |
| 13A | Hex₄N⁺ BETI | 10 | ±2.35 | ±0.99 | 5 |
| 13B | Hex₄N⁺ BETI | 5 | ±2.83 | ±1.43 | 5 |
| 14A | Et₄N⁺ Imide | 10 | ±0.14 | ±0.04 | 5 |
| 14B | Et₄N⁺ Imide | 5 | ±1.31 | ±0.38 | 5 |
| 15A | Bu₄N⁺ Methide | 10 | ±4.99 | ±1.75 | 5 |
| 15B | Bu₄N⁺ Methide | 5 | ±13.60 | ±3.66 | 5 |
| 16A | Et₃NH⁺ Methide | 10 | ±2.17 | ±0.86 | 5 |
| 16B | Et₃NH⁺ Methide | 5 | ±10.42 | ±3.07 | 5 |
| 17A | C₁₂NMe₃⁺ BETI | 10 | ±0.53 | ±0.19 | 5 |
| 17B | C₁₂NMe₃⁺ BETI | 5 | ±1.34 | ±0.53 | 5 |
| Control | None | | WNC | WNC | 5 |

Counterion Key:
Dibutylimide = —N(SO₂C₄F₉)₂
Imide = —N(SO₂CF₃)₂
Methylbutylimide = —N(SO₂CF₃)(SO₂C₄F₉)
BETI = —N(SO₂C₂F₅)₂
Methide = —C(SO₂CF₃)₃

A 10 g portion of N,N-diethylaminoethyl acrylate Q-salt, methosulfate (50% aq.) (purchased from Monomer-Polymer & Dajac Labs, Inc, catalog no. 8592) was mixed with 6.0 g 80 wt % aqueous solution of HQ115 (lithium bis(trifluoromethanesulfonyl)imide, obtained from 3M Company) in a screw-top vial. The slightly hazy mixture was extracted with 100 ml dichloromethane, then the organic layer was isolated and washed with two 50-ml portions of deionized water. Solvent removal and drying on a rotary evaporator left 4.2 g light amber, slightly hazy liquid. Analysis of the product by proton and fluorine NMR showed it to be a mixture consisting of approximately 86.6 wt % hydroxyethyldiethylmethylammonium bis(trifluoromethanesulfonyl)imide, 2.6 wt % hydroxyethyldiethylammonium bis(trifluoromethanesulfonylimide), 2.2 wt % acrylic acid, and 6.2 wt % methacrylic acid, with the remainder as unidentified impurities. This antistat was used to prepare the brightness enhancing film for Example 18A of Table 4.

Example 19A of Table 4 employed triethylammonium bis(perfluoroethanesulfonyl)imide, (C₂H₅)₃NH^{+ -}N(SO₂C₂F₅)₂, as the antistat, prepared as described in Example 1 of U.S. Pat. No. 6,372,829 example 1.

In both cases, these antistat compositions were combined with the polymerizable resin composition previously described at the concentration(s) set forth in the following Table 4. This resin compositions were then prepared into a brightness enhancing film as previously described using “Vikuiti™ DBEF II” as the substrate. The test results were as follows:

TABLE 4
Antistatic Salts in the Polymerizable Resin on MOF Substrate
of “Vikuiti ™ DBEF II”

| | | Charge Decay | |
|---|---|---|---|
| | | Prisms | |
| | | perpendicular | Blooming |
| Sample ID | Loading | to electrodes | Test |
| 18A | 5% | 0.59 | P |
| 19A | 5% | 0.26 | P |

1. A brightness enhancing film comprising a polymerized microstructured surface wherein the microstructures comprise the reaction product of a polymerizable resin composition comprising an antistatic agent having the general formula
RₓJH₄₋ₓ^{+ -}A[SO₂R_{f}]ₘ
wherein
x ranges from 3-4;
R is independently a C₁ to C₁₂ alkyl group optionally comprising catenary oxygen atoms or at least one hydroxyl terminal group;
J is nitrogen or phosphorus;
A is a nitrogen or carbon;
R_{f} is independently a fluorinated C₁ to C₄ alkyl group; and
m ranges from 2 to 3.

2. The brightness enhancing film of claim 1 wherein the antistatic agent is present in an amount ranging from about 0.5 wt-% to about 15 wt-% solids.

3. The brightness enhancing film of claim 1 wherein the antistatic agent is present in an amount ranging from about 3 wt-% to about 5 wt-% solids.

4. The brightness enhancing film of claim 1 wherein the charge decay is less than 1.5 seconds when tested at 70° F. and 50% relative humidity.

5. The brightness enhancing film of claim 1 wherein the charge decay is no greater than about 0.5 seconds when tested at 70° F. and 50% relative humidity.

6. The brightness enhancing film of claim 1 wherein the microstructures disposed on a base film layer having a different composition than the micro structures.

7. The brightness enhancing film of claim 6 wherein the base film layer further comprises a primer.

8. The brightness enhancing film of claim 6 wherein the base film layer comprises a polyester.

9. The brightness enhancing film of claim 8 wherein the base film layer is a polarizing film.

10. The brightness enhancing film of claim 8 wherein the primer comprises a sulfonated polyester.

11. The brightness enhancing film of claim 6 wherein the microstructures exhibit a crosshatch adhesion to the base film layer of at least 90%.

12. The brightness enhancing film of claim 1 wherein the sum of the carbon atoms of R is at least 5.

13. The brightness enhancing film of claim 12 wherein x is 4 and the sum of the carbon atoms of R is at least 7.

14. The brightness enhancing film of claim 12 wherein at least one Rf is CF₃

15. The brightness enhancing film of claim 12 wherein at least one R is methyl and the other R groups comprise at least 2 carbon atoms.

16. The brightness enhancing film of claim 15 wherein the antistatic agent is selected from the group consisting of (C₂H₅)₃N(CH₃)^{+ -}N(SO₂CF₃)₂, (C₄H₉)₃N(CH₃)^{+ -}N(SO₂CF₃)₂, and mixtures thereof.

17. The brightness enhancing film of claim 12 wherein x is 3, and each R comprises at least 2 carbon atoms.

18. The brightness enhancing film of claim 17 wherein the antistatic agent is selected from the group consisting of (C₂H₅)₃NH^{+ -}N(SO₂CF₃)₂, (C₂H₅)₃NH^{+ -}N(SO₂C₄F₉)₂, (C₂H₅)₃NH^{+ -}N(SO₂CF₃)(SO₂C₄F₉), (C₂H₅)₃NH^{+ -}C(SO₂CF₃)₃, (C₂H₅)₃NH^{+ -}N(SO₂C₂F₅)₂, and mixtures thereof.

19. The brightness enhancing film of claim 12 wherein x is 4 and the sum of the carbon atoms of R is at least 8.

20. The brightness enhancing film of claim 19 wherein the antistatic agent is selected from the group consisting of (C₄H₉)₄N^{+ -}N(SO₂CF₃)₂, (C₂H₅)₄N^{+ -}N(SO₂CF₃)₂, (C₄H₉)₄N^{+ -}C(SO₂CF₃)₃, (C₆H₁₃)₄N^{+ -}N(SO₂C₂F₅)₂, (C₁₂H₂₅)(CH₃)₃N^{+ -}N(SO₂C₂F₅)₂, and mixtures thereof.

21. The brightness enhancing film of claim 1 wherein J is nitrogen.

22. The brightness enhancing film of claim 1 wherein when J is phosphorus x is 4.

23. The brightness enhancing film of claim 1 wherein R comprises at least one hydroxyl terminal group.

24. The brightness enhancing film of claim 1 wherein the polymerizable resin composition further comprises at least one carboxylic acid.

25. The brightness enhancing film of claim 24 wherein polymerizable resin comprises at least one monocarboxylic acid.

26. The brightness enhancing film of claim 25 wherein the monocarboxylic acid is selected from the group consisting of acrylic acid, methacrylic acid, and mixtures thereof.

27. A polymerizable resin comprising at least one di(meth)acrylate monomer comprising at least two aromatic rings, a reactive diluent; and an antistatic agent having the general formula
RₓJH₄₋ₓ^{+ -}A[SO₂R_{f}]ₘ
wherein
x ranges from 3-4; and
R is independently a C₁ to C₁₂ alkyl group optionally comprising catenary oxygen atoms or at least one hydroxyl terminal group;
J is nitrogen or phosphorus;
A is a nitrogen atom or carbon atom;
R_{f} is independently a fluorinated C₁ to C₄ alkyl group
m ranges from 2 to 3.

28. A microstructured film article comprising a polymerized microstructured surface wherein the microstructures comprise the reaction product of a polymerizable resin composition comprising an antistatic agent having the general formula
RₓJH₄₋ₓ^{+ -}A[SO₂R_{f}]ₘ
wherein
x ranges from 3-4; and
R is independently a C₁ to C₁₂ alkyl group optionally comprising catenary oxygen atoms or hydroxyl terminal groups;
J is nitrogen or phosphorus;
A is a nitrogen atom or carbon atom;
R_{f} is independently a fluorinated C₁ to C₄ alkyl group
m ranges from 2 to 3.
